(19) United States
(12) Patent Application Publication
(10) Pub. No.: US 2015/0346952 A1
(43) Pub. Date: Dec. 3, 2015

(54) CONTROL CENTER REFINEMENTS

(71) Applicant: Apple Inc., Cupertino, CA (US)

(72) Inventors: Lawrence Y. Yang, San Francisco, CA (US); Chanaka G. Karunamuni, San Jose, CA (US); Imran A. Chaudhri, San Francisco, CA (US)

(21) Appl. No.: 14/727,747

(22) Filed: Jun. 1, 2015

Related U.S. Application Data
(60) Provisional application No. 62/005,655, filed on May 30, 2014.

(51) Int. Cl. G06F 3/0481; G06F 3/0486; G06F 3/0484; G06F 3/0482; G06F 3/0488

(52) U.S. Cl. CPC G06F 3/04817; G06F 3/0482; G06F 3/0488; G06F 3/04842; G06F 3/0486

(57) ABSTRACT

User-selected application icons can be added into a control center interface. The corresponding applications may be accessed either from the springboard or from the control center interface. Operation of slider controls in the control center interface can temporarily fade out all aspects of the control center interface except for the slider control being operated during that control's operation. The temporary fading out of most of the other aspect of the control center interface causes the content that had been at least partially obscured and overlaid by the previously opaque control center interface to become visible during the slider control's operation. While the slider control is being actively operated, the control center interface becomes transparent except for the control itself. Consequently, the effects of the slider control's operation relative to the value of the parameter to which it pertains are immediately apparent during that operation.

### PRIORITY APPLICATIONS

This application claims the benefit of U.S. Provisional Patent Application Ser. No. 62/005,655, filed on May 30, 2014, titled “CONTROL CENTER REFINEMENTS,” which is incorporated by reference herein in its entirety.

### CROSS-REFERENCES TO RELATED APPLICATIONS

This application is related to U.S. Provisional Patent Application Ser. No. 62/005,628, filed on May 30, 2014, titled “USER INTERFACE SLIDER THAT REVEALS THE ELEMENT IT AFFECTS,” which is incorporated by reference herein in its entirety.

### BACKGROUND OF THE INVENTION

Mobile devices such as smart phones allow users to interact with a host of applications that are stored in the memory of those mobile devices. Such applications can include telephony applications, scheduling applications, e-mail applications, navigational applications, Internet browsing applications, social media applications, music applications, gaming applications, book-reading applications, etc. A graphical interface presented on a display of the device can include various different icons that correspond to these applications. The icons can be arranged in a grid, for example.

Many mobile devices are equipped with a touch-sensitive display that permits a user to contact a location on the display in order to make a selection. Some mobile devices are capable of detecting, through the touch-sensitive display, more complex gestures that can be assigned different meanings. Such gestures can include single taps, double taps, holds, swipes, drags, pinches, rotations, etc. Gestures can involve one or several of the user's digits. An example mobile device interprets a single-tap at the location of a particular icon as indicating the user's intent to launch (i.e., execute or open) a particular application to which that particular icon corresponds.

Because the display size of a mobile device is made relatively small to enable portability, and because icons ought to be large enough to identify the applications that they represent, the quantity of icons that can be presented concurrently on a mobile device's display is fairly limited. Nevertheless, a mobile device often will be capable of storing numerous applications—more than can be represented by icons on a single screen. In order to permit a user to access all of these numerous application, a mobile device's user interface can be segmented into multiple separate screens. Each such screen can contain a different subset of all of the icons for the applications store don the mobile device.

The mobile device can present one such screen at a time on its touch-sensitive display. The screens can be sequentially related to each other, such that one screen may logically precede or follow another screen in a set order. In response to detecting a left or right swipe gesture relative to the touch-sensitive display, the mobile device can cause a currently obscured screen preceding or following the currently presented screen to be presented instead, effectively swapping between screens of application-representing icons. The screen that is currently being displayed is sometimes called the “springboard.”

Under some circumstances, some of the applications stored on a mobile device might be accessed much more frequently than other applications. A user of the mobile device might wish to be able to launch these frequently accessed application quickly. If the mobile device is currently presenting a screen other than the one that contains the icon for the application that the user wishes to launch, then the user might find it inconvenient to be required to scroll through potentially multiple different screens in a hunt for the icon of interest. In order to allow a user to launch frequently used applications regardless of the graphical interface screen that is currently being presented, a mobile device can present, concurrently with the springboard, a section of the screen that remains constant throughout the screen-swapping activity described above. This section is sometimes called the “dock.”

The dock can be distinguished from the remainder of the display through a difference in coloration or shading. The dock typically occupies a fraction of the display—usually large enough to contain a single row of icons. Often, the dock is shown at the bottom of a mobile device's touch-sensitive display. In response to detecting dragging gestures, a mobile device can move icons from the springboard into the dock or from the dock back onto the springboard. When the mobile device swaps the screen that is currently being displayed, the icons contained in the dock remain in place even while other icons move off of and onto the display. Icons in the dock are quickly accessible regardless of which of the screens of the user interface is currently being presented as the springboard.

FIG. 1 is a diagram that illustrates an example of a mobile device 100 having a touch-sensitive display that concurrently presents a springboard and a separate dock. Mobile device 100 can be a smart phone such as an Apple iPhone, for example. Mobile device 100 can have a display that shows application icons 102 in a springboard of the operating system user interface. On this display, mobile device 100 can additionally show application icons 104 in a dock of the operating system user interface. By detecting single-taps and double-taps relative to application icons 102 and 104, the operating system of mobile device 100 can execute, or launch (i.e., start processes for), corresponding applications that are stored within the persistent memory of mobile device 100, and automatically send single-tap or double-tap signals (depending on the type of tap detected) to those applications.

FIG. 2 is a diagram that illustrates an example 200 of a mobile device 202 that has a multi-virtual screen operating system user interface. The multi-virtual screen operating system user interface includes virtual screens 204, 206, 208, and 210. Each such virtual screen is a separate segment of the user interface. Only one of the virtual screens is displayed at a time by mobile device 202; in this case, virtual screen 204 is currently selected for display by a user of mobile device 202. The user of mobile device can instruct mobile device 202 to display different ones of virtual screens 204, 206, 208, and 210 at different moments in time, typically through gestures made relative to a touchscreen of mobile device 202. In response to certain user gestures, mobile device 202 can move a user interface element (e.g., an application icon or other graphical widget) from one virtual screen to another virtual screen.

As is discussed above, mobile device 202 can be configured to maintain, on its display, the icons in the dock even when changing the presentation of the currently active virtual screen to a different one of virtual screens 204, 206, 208, and 210. Although most of the icons on the previously active virtual screen may be replaced on the display by the icons on the newly active virtual screen after such a change, the icons in the dock remain constant throughout the change.

Applications stored on a mobile device can have associated configurations. Various parameters of applications can have different user-specified settings. Other parameters may be applicable to the mobile device's operating system or to the mobile device as a whole. The user of a mobile device might find it inconvenient, when desiring to modify the value of a particular application's parameter, to have to find that application's icon and launch it. This may be especially true when the parameter is one whose value the user often wants to change. For example, a music playing application stored on the mobile device might have a volume setting. As the mobile device's user might frequently listen to music while concurrently using other applications stored on the mobile device, the user might find it inconvenient to locate the icon for the music playing application and launch it every time that he wants to modify the value of the volume parameter.

At least partially to avoid this inconvenience, a mobile device's operating system can include a “control center.” The control center can include controls that can be manipulated by a user in order to modify parameters of a variety of different applications that are stored on the mobile device. Thus, different applications each can have the values of their parameters set or modified within the control center without requiring the individual launch of each application. An operating system of the mobile device can cause a control center interface, containing the various controls, to appear on its display in response to a user gesture.

For example, while any content (the springboard or some application's content) is being displayed on the mobile device's display, the mobile device's detection of a swiping gesture originating from the bottom of the display and directed upward can cause the control center interface to rise up and appear from the bottom of the display. When presented, the control center interface can at least partially obscure the content that was being displayed prior to the appearance. Optionally, unlike some other interfaces that the mobile device might be capable of presenting, the mobile device can be designed such that the control center interface can be called up from any state in which the mobile device might currently be operating.

FIG. 3 is a diagram that shows an example 300 of a control center interface 302 that at least partially overlays and obscures content that was being displayed prior to the control center interface's invocation. Control center interface 302 can obscure much, but potentially less than all, of the content over which it is laid. As shown in FIG. 3, the uppermost regions of the springboard are still visible even while control center interface 302 is overlaid on top of the springboard. Control center interface 302 can include a handle 318 with which a user can interact in order to cause control center interface 302 to retract downward and disappear until recalled. A downward dragging gesture relative to handle 312 can cause control center interface 302 to retract, for example. Upon retraction, the content that control center interface 302 previously at least partially obscured becomes entirely visible once again.

Control center interface 302 can include toggles 304 for various aspects of the mobile device. Toggles 304 can be activated or deactivated through tap gestures in order to turn various features of the mobile device alternatively on and off. For example, toggles 304 can include a toggle for activating and deactivating airplane mode, a toggle for activating and deactivating WiFi capability, a toggle for activating and deactivating Bluetooth capability, a toggle for activating and deactivating a “do not disturb” mode, and a toggle for activating and deactivating a portrait/landscape orientation lock.

Control center interface 302 can also include sliders 306 and 310 for various aspects of the mobile device. Sliders 306 and 310 can pertain to specific applications and/or to the mobile device's operating system as a whole. As shown, slider 306 is operable to change the brightness of the display of the mobile device. Slider 310 is operable to change the volume of the sound output of the mobile device. As is characteristic of many of the controls in control center interface 302, user interaction with sliders 306 and 310 can modify the values of parameters that affect multiple applications executing on the mobile device simultaneously. This characteristic makes the placement of these kinds of controls within control center interface 302 very useful.

Control center interface 302 can also include playback controls 308. Playback controls 308 can include a rewind control, a play control, and a fast forward control. Playback controls 308 can be operated to influence the playback of a variety of different media, potentially including both music and motion video content. User interaction with playback controls 308 can affect the speed, direction, and location of presentation of whatever time-spanning media the mobile device is currently presenting, regardless of the specific form that media takes, and regardless of which specific application is presenting that media.

Control center interface 302 can also include controls that can be used to launch or modify the values of parameters of specific applications on the mobile device. For example, user interaction with control 314 can cause the mobile device to launch or switch contexts to an Internet web browsing application. Application icons 312 also can be used to launch, switch contexts to, or modify the values of parameters of various applications stored on the mobile device. For example, a flashlight application icon can be operated to toggle on or off a flash bulb that is present on the reverse side of the mobile device. For other examples, a clock application icon, a calculator application icon, and a camera application icon each can be operated to cause the mobile device to launch or switch contexts to corresponding applications. Each of controls 304-316 is a user interface element.

Although application icons 312 are similar in function to application icons 102 and 104 in the springboard and dock of FIG. 1, presently application icons 312 are fixed in kind and quantity. Presently, users of the mobile device have no control over which applications are represented or how many applications are represented in control center interface 302.

### BRIEF SUMMARY OF THE INVENTION

Techniques described herein enable the addition of user-selected application icons from a springboard and/or dock into a control center interface. The addition does not necessarily remove the selected application icons from their original positions in the springboard or dock, but can instead create a new copy of those application icons in the control center interface, such that the corresponding applications can be accessed either from the springboard or from the control center interface. Furthermore, techniques described herein enable the removal of user-selected application icons from the control center interface. Such removal can involve simple deletion or movement into the springboard or dock.

Techniques described herein further enhance the operability of one or more slider controls in the control center interface by temporarily fading out all aspects of the control center interface except for the slider control being operated during that control's operation. The temporary fading out of most of the other aspect of the control center interface causes the content that had been at least partially obscured and overlaid by the previously opaque control center interface to become visible during the slider control's operation. While the slider control is being actively operated (e.g., while user contact with the slider control is maintained), the control center interface becomes transparent except for the control itself. Consequently, the effects of the slider control's operation relative to the value of the parameter to which it pertains are immediately apparent during that operation.

For example, the operation of a brightness control within the control center can cause all parts of the control center interface except for the brightness control to become transparent, thereby revealing the content overlaid by the control becoming brighter or darker as the slider thumb is moved toward either of the control's extents. Cessation of user contact with the slider control can cause the previously faded aspects of the control center to become opaque once again, thereby at least partially obscuring the overlaid content as prior to the slider control's operation.

Alternatively, under circumstances in which the control center interface only obscures a part of the content that it partially overlays, such that the part remains visible (e.g., above the top of the control center interface) even though the control center is opaque, operation of a slider control can cause the effects of the change of the value of the parameter to be made apparent with respect just to the visible part of the mostly overlaid background content, as that change is being made. For example, in such an alternative, user operation of a brightness control can cause the fraction of the background content still visible above the top edge of the control center to become brighter or darker as the slider thumb is moved toward either of the control's extents. This effect can be achieved while maintaining the opacity of the control center interface as usual.

### BRIEF DESCRIPTION OF THE DRAWINGS

FIG. 1 is a diagram that illustrates an example of a mobile device having a touch-sensitive display that concurrently presents a springboard and a separate dock.

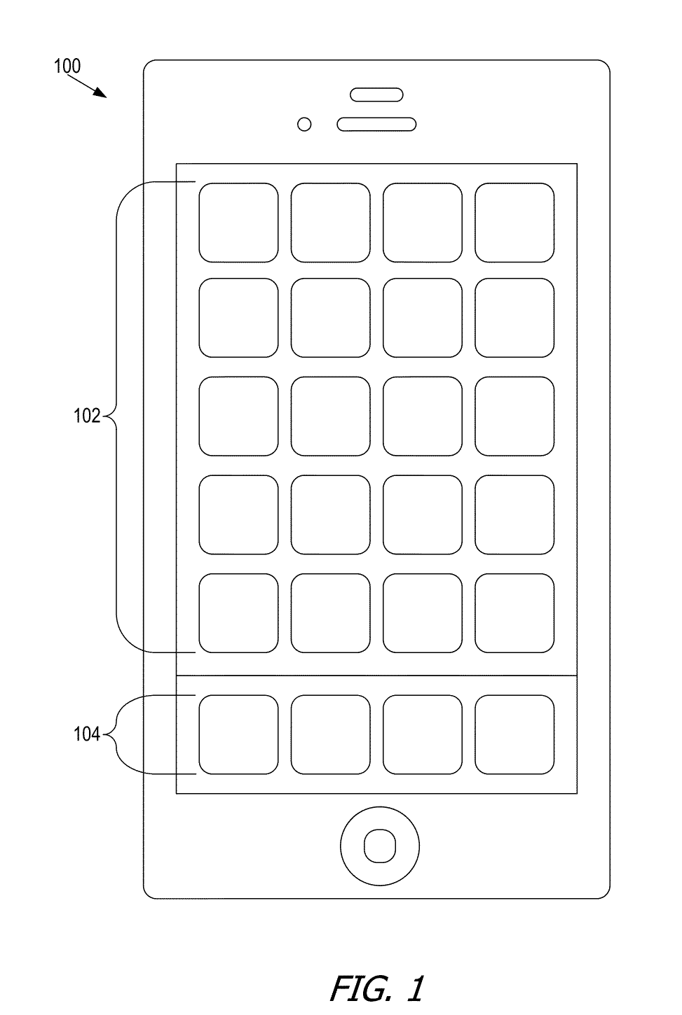

FIG. 2 is a diagram that illustrates an example of a mobile device that has a multi-virtual screen operating system user interface.

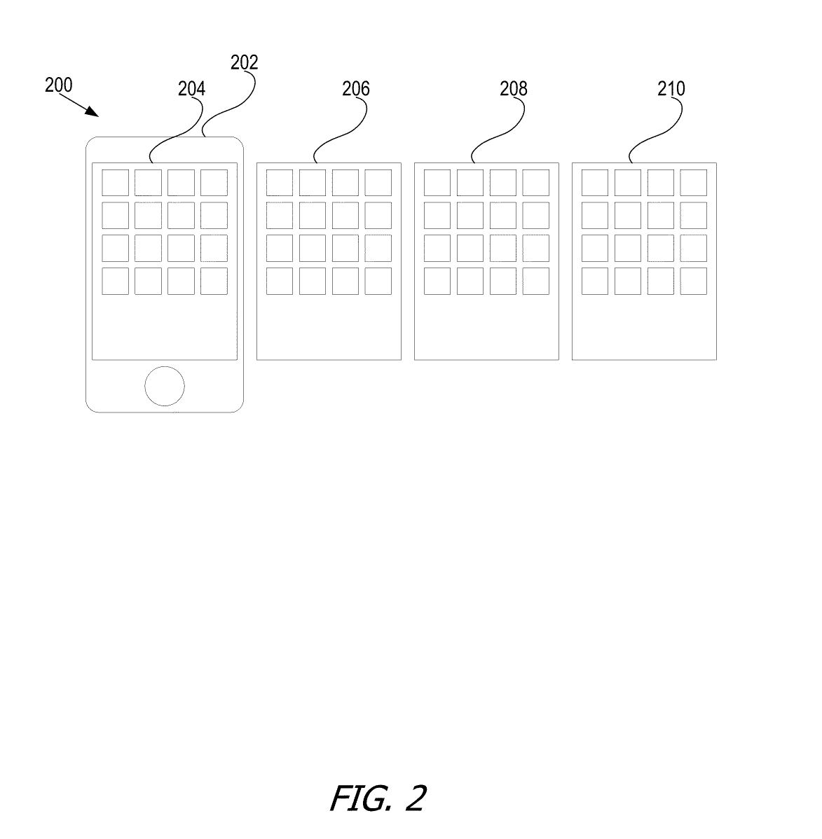

FIG. 3 is a diagram that shows an example of a control center interface that at least partially overlays and obscures content that was being displayed prior to the control center interface's invocation.

FIG. 4 is a diagram that illustrates an example of a control center interface in which an expanded quantity of application icons is included within the control center interface through the use of pagination, according to an embodiment of the invention.

FIG. 5 is a diagram that illustrates an example of a control center interface in which an expanded quantity of application icons is included within the control center interface through the use of row stacking, according to an embodiment of the invention.

FIG. 6 is a diagram that illustrates an example of a control center interface that includes a control that can be operated to add a new application to the control center interface, according to an embodiment of the invention.

FIG. 7 is a diagram that illustrates an example of an application selection interface that enables a user of a mobile device to select a particular application from a set of applications that are stored on the mobile device, according to an embodiment of the invention.

FIG. 8 is a diagram that illustrates an example of a control center interface to which a new application icon has been added through the use of an add icon, according to an embodiment of the invention.

FIG. 9 is a diagram that illustrates an example of a control center interface that has entered a mode in which application icons are selectable for removal from the control center interface, according to an embodiment of the invention.

FIG. 10 is a diagram that illustrates an example of a springboard in which an reconfiguration mode has been entered, according to an embodiment of the invention.

FIG. 11 is a diagram that illustrates an example of a control center interface that has been raised over a springboard while an application icon is being dragged into the control center interface, according to an embodiment of the invention.

FIG. 12 is a diagram that illustrates an example of a control center interface into which an application icon has been dragged from a springboard, according to an embodiment of the invention.

FIG. 13 is a diagram that illustrates an example of a control center settings interface that shows application icons that are already contained in the control center and an add icon that can be used to add new application icons to the control center, according to an embodiment of the invention.

FIG. 14 is a diagram that illustrates an example of a control center settings interface that shows multiple applications for which default functionality can be specified, according to an embodiment of the invention.

FIG. 15 is a diagram that illustrates an example of a control center settings interface that includes a list of default functions that can be invoked upon application launch of a previously selected application, according to an embodiment of the invention.

FIG. 16 is a diagram that illustrates an example of a control center interface that includes a control that can be operated to add a new application to multiple rows of application icons in control center interface, according to an embodiment of the invention.

FIG. 17 is a diagram that illustrates an example of a control center interface that includes an application-adding control that appears in response to the mobile device being placed in an reconfiguration mode, according to an embodiment of the invention.

FIG. 18 is a diagram that illustrates an example of a control center interface that has been made transparent except for a slider control that is currently being operated, according to an embodiment of the invention.

FIG. 19 is a diagram that illustrates an example of a control center interface including a slider control which, when activated, causes effects of the change in value of a parameter associated with that slider control to become apparent relative to background content visible in a portion of the display that the control center interface does not occupy, according to an embodiment of the invention.

FIG. 20 is a diagram that illustrates an example of a control center interface in which different regions or sections of the control center are distinguished from each other via differing transparencies of membranes on which those regions or sections are composed.

FIG. 21 is a simplified block diagram of an implementation of a device according to an embodiment of the present invention.

### DETAILED DESCRIPTION OF THE INVENTION

Described herein are various enhancements to a control center interface that a mobile device can present. The control center interface can be different from other interfaces that the mobile device's operating system can present in a variety of ways. For example, in one embodiment, the control center interface can be called forth while the mobile device is in any state of operation, regardless of whether the mobile device is currently actively presenting application content or not. For another example, in one embodiment, the control center interface can include controls that affect parameters of various different applications stored on the mobile device, making it unnecessary to launch those applications in order to adjust the values of those parameters. For yet another example, in one embodiment, the control center interface can include controls that affect parameters that universally influence multiple applications simultaneously. For example, a brightness slider control can affect the brightness of all visual content that the mobile device presents, while a volume slider control can affect the volume of all visual content that the mobile device presents.

Optionally, applications that are stored in a mobile device's memory can specify custom functionality for those applications that can be accessed from the control center interface through those applications' icons that are present in that interface. For example, a social networking application might include a function invocable from its control center interface icon to allow a status update to be posted to a user's social networking profile. In that scenario, a user could interact with the social networking application's icon in the control center interface to cause a status update to be posted to his social networking profile without launching the social networking application from the springboard or dock.

Among the enhancements described herein are techniques that permit a user to adjust which application icons are contained within the control center interface. The enhancements can allow a user to drag icons from other interfaces, such as the springboard and/or dock, into the control center interface, for example. The enhancements described herein can also enable a user to adjust the quantity of application icons that are contained within the control center interface. In this manner, the user is empowered to generate a highly customized control center interface that contains the features that the user most often wants to access, and that omits other features that the user less wants to access less often.

### Changing a Quantity of Application Icons in the Control Center Interface

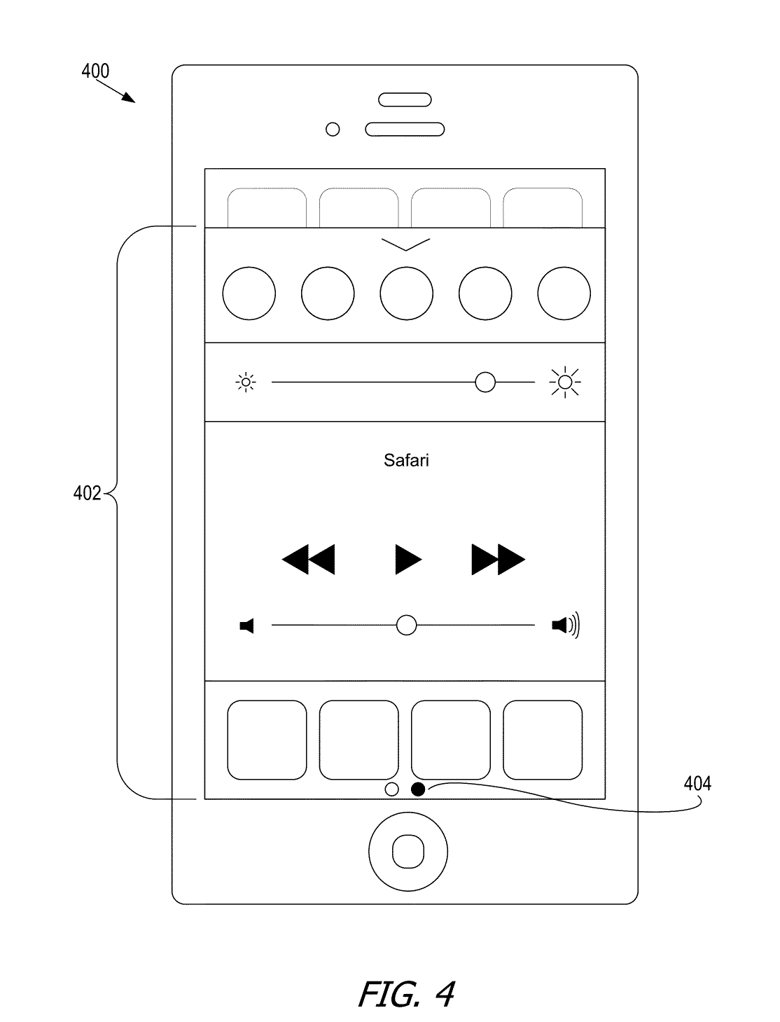

FIG. 4 is a diagram that illustrates an example 400 of a control center interface 402 in which an expanded quantity of application icons is included within the control center interface through the use of pagination, according to an embodiment of the invention. As shown, pagination dots 404 include one dot that is filled-in or otherwise highlighted, along with another dot that is not filled-in or otherwise highlighted. Although two pagination dots 404 are shown in this example, alternative embodiments of the invention can include different quantities of dots.

The quantity of dots is representative of the quantity of virtual pages or virtual rows of application icons that are contained within control center interface 402. Each of pagination dots 404 is representative of a different virtual page or row. In one embodiment, each virtual page or row can include up to four different application icons. The currently highlighted dot indicates which of the several virtual pages or rows of application icons is currently being presented at the bottom of control center interface 402.

In an embodiment, addition of a new application icon to the control center when the currently presented virtual page or row can cause a new virtual page or row to be created for control center interface 402, and for the new application icon to be added to the newly created virtual page or row. The creation of a new virtual page or row also can cause a new pagination dot to be added to pagination dots 404. Conversely, the removal of the last application icon from a particular virtual page or row of the control center can cause that particular virtual page or row to be deleted, along with its representative one of pagination dots 404.

According to an implementation, while the mobile device is presenting control center interface 402, the mobile device can detect a leftward or rightward swiping gesture made by a user in the vicinity of the application icons. The detection of this swiping gesture can cause the mobile device to change which virtual row of application icons is currently being presented at the bottom of control center interface 402. The mobile device's presentation of a different virtual row of application icons in this manner also can cause the mobile device to highlight a different one of pagination dots 402 in order to signify which of the virtual rows is currently being presented.

For example, if the mobile device is currently presenting the second of two virtual rows of application icons at the bottom of control center interface 402, then the mobile device's detection of a rightward swiping gesture can cause the mobile device (a) to move the second of the two virtual rows rightward out of bounds of the display and (b) to move the first of the two virtual rows rightward virtually from beyond the display into the bounds of the display. This gesture can also cause the mobile device to remove the highlighting from the rightmost of pagination dots 404 and to add highlighting to the leftmost of pagination dots 404, signifying that the first of the two virtual rows of application icons is now the currently active virtual row. The remainder of the content of control center interface 402 can remain unaffected by the selection of a different virtual row of application icons.

For another example, if the mobile device is currently presenting the first of two virtual rows of application icons at the bottom of control center interface 402, then the mobile device's detection of a leftward swiping gesture can cause the mobile device (a) to move the first of the two virtual rows leftward out of bounds of the display and (b) to move the second of the two virtual rows leftward virtually from beyond the display into the bounds of the display. This gesture can also cause the mobile device to remove the highlighting from the leftmost of pagination dots 404 and to add highlighting to the rightmost of pagination dots 404, signifying that the second of the two virtual rows of application icons is now the currently active virtual row. As in the previous example, the remainder of the content of control center interface 402 can remain unaffected by the selection of a different virtual row of application icons.

Thus, in one embodiment, the mobile device can determine that a maximum number of application launch icons is presently displayed in a row of one or more application launch icons. In response to determining that the maximum number of application launch icons is presently displayed in the row of one or more application launch icons, the mobile device can do the following. The mobile device can create, in the control interface, a pagination indicator including a separate element for each page of two or more pages of the control interface. The mobile device can also add the application launch icon to a new row of application launch icons on a second page that is not displayed concurrently with a first page on which the maximum number of application launch icons was displayed. The first page and the second page are both included within the two or more pages.

In an implementation, the mobile device might not reveal pagination dots 404 until there is more than one virtual page or row of application icons in control center interface 402. According to one technique, the mobile device might reveal pagination dots 404 in response to prospective creation of the second virtual page or row through the addition of a new application icon to control center interface 402. Example techniques for adding new application icons to control center interface 402 are discussed further below.

Beneficially, the pagination model illustrated in connection with FIG. 4 permits a very large quantity of application icons to be added to control center interface 402. However, only a subset of all of the control center's application icons are presented concurrently within this pagination model.

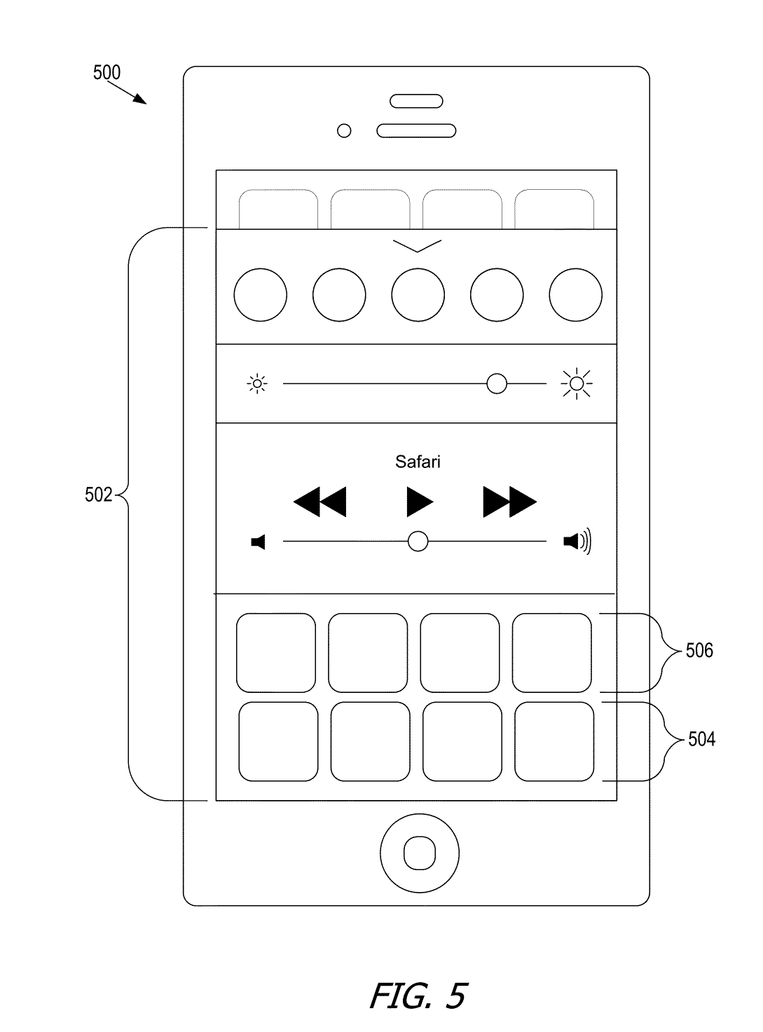

FIG. 5 is a diagram that illustrates an example 500 of a control center interface 502 in which an expanded quantity of application icons is included within the control center interface through the use of row stacking, according to an embodiment of the invention. In an embodiment, addition of application icons to control center interface 502 can begin with the filling of a lowermost, and at that time, only row 504 of application icons. When row 504 is filled, the addition of another application icon can cause the mobile device to generate a new row 506 above former row 504. The newly added application icon can be placed within new row 506. Row 504 is a row of application launch icons, and the application icons therein can be application launch icons that are operable to launch applications stored in the memory of the mobile device.

Addition of new row 506 to control center interface 502 can cause the mobile device to compress, at least slightly, other controls that are present within control center interface 502 in order to make room for new row 506. Conversely, the removal of the last application icon from row 506 can cause mobile device to remove row 506 and to expand the spacing of the previously compressed other controls of control center interface 502. Thus, in one embodiment, the mobile device can determine that a maximum number of application launch icons is presently displayed in the row of one or more application launch icons. In response to determining that a maximum number of application launch icons is presently displayed in the row of one or more application launch icons, the mobile device can (a) display, in the control interface, a new row concurrently with the row containing maximum number of application launch icons, and (b) add the application launch icon to the new row.

Beneficially, the stacked row model illustrated in connection with FIG. 5 permits all of the control center's application icons are presented concurrently on one screen, eliminating the need for the user to navigate to other virtual screens. However, limited available space within control center interface 502 can potentially impose a cap on the quantity of application icons that can be included within control center interface 502.

### Adding an Application Icon to the Control Center Interface

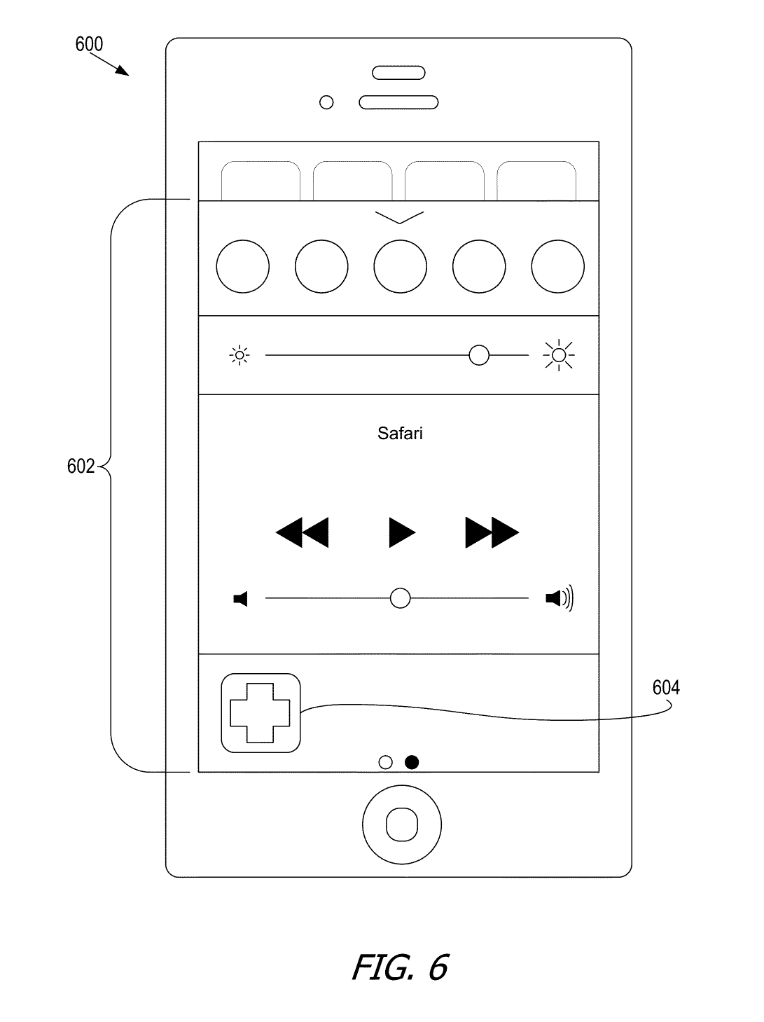

FIG. 6 is a diagram that illustrates an example 600 of a control center interface 602 that includes a control that can be operated to add a new application to control center interface 602, according to an embodiment of the invention. As shown, control center interface 602 includes an add icon 604 on which a user can tap in order to cause the mobile device to initiate a procedure for adding a new application icon to control center interface 602. An example of a process that the mobile device can follow in order to accomplish the selection of the new application icon is described below. Add icon 604 is an application addition icon.

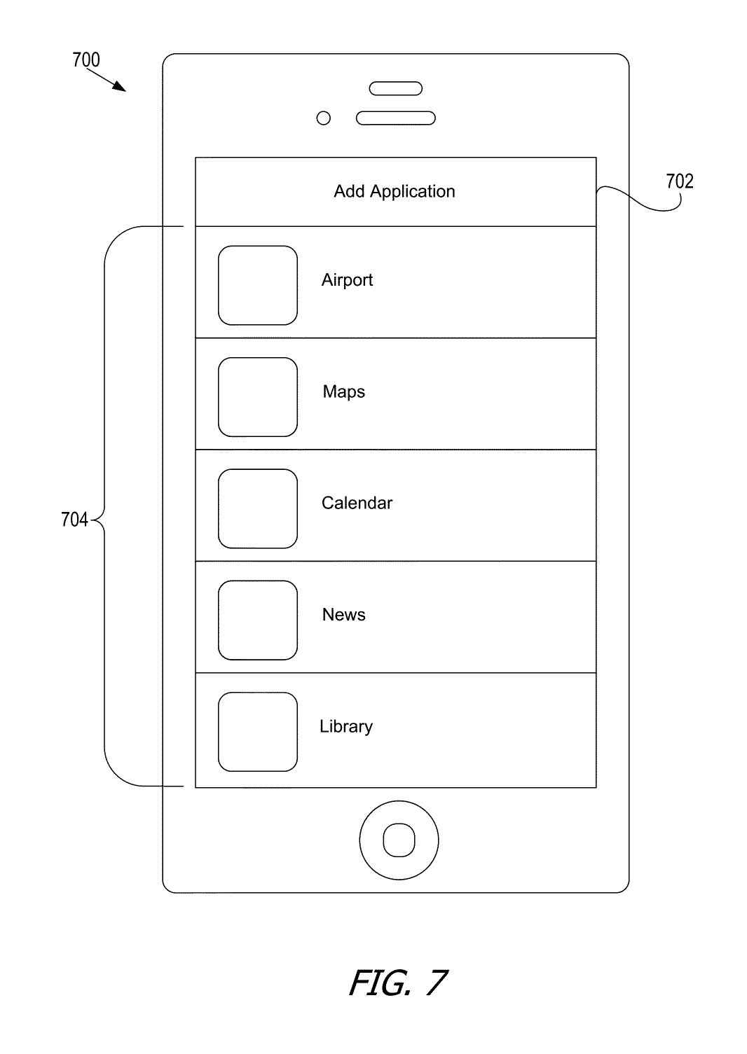

FIG. 7 is a diagram that illustrates an example 700 of an application selection interface 702 that enables a user of a mobile device to select a particular application from a set of applications that are stored on the mobile device, according to an embodiment of the invention. According to an implementation, in response to a user's activation of add icon 604 shown in FIG. 6, the mobile device presents application selection interface 702. Application selection interface 702 is an application selection screen.

Application selection interface 702 can include a separate row for each application that is stored on the mobile device and that has an application icon that can be added to the control center interface. These are shown as rows 704 in FIG. 7. Each row can include a title or name of the application and an associated application icon. In the likely event that the mobile device stores more applications than can be concurrently shown in application selection interface 702, application selection interface 702 can include a control, such as a vertical slider control (not shown), that permits the user of the mobile device to scroll the display to other applications off-screen in the application list.

In one technique, the mobile device detects a user tapping gesture relative to one of rows 704, signifying that the user has selected the corresponding application for inclusion within the control center interface. An example of a process whereby the mobile device places the selected application's icon within the control center interface is described below.

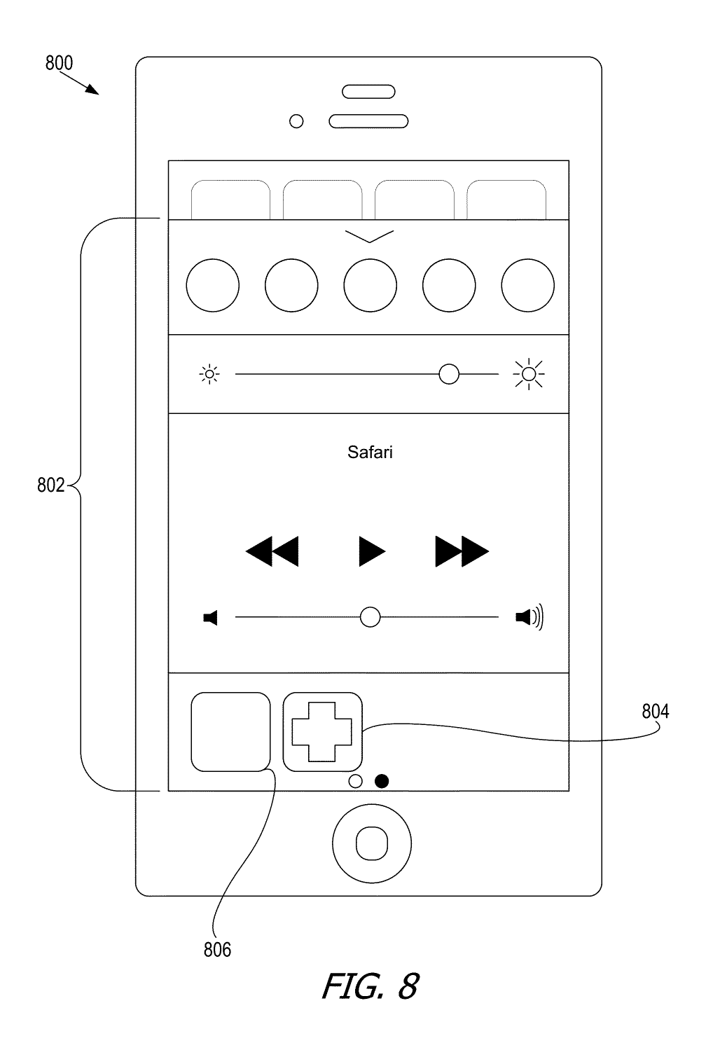

FIG. 8 is a diagram that illustrates an example 800 of a control center interface 802 to which a new application icon has been added through the use of an add icon, according to an embodiment of the invention. As shown, a new application icon 806 has been added to the row of application icons shown at the bottom of control center interface 802. In an embodiment, new application icon 806 can be the application icon that was displayed next to and in conjunction with the application that was selected from application selection interface 702 of FIG. 7. Add icon 804, which is essentially the same as add icon 604 of FIG. 6, has been moved one icon width to the right in order to make room for application icon 806. Thus, in one embodiment, the mobile device can display a control interface on a touch-sensitive screen. The control interface can includes one or more user interface elements that are operable to modify settings of one or more applications accessible on the device. The user interface elements can include an application addition element which, when activated, displays an application selection screen. The mobile device can detect a first contact on the touch-sensitive screen. The first contact can correspond to the application addition element. In response to detecting the contact corresponding to the application addition element, the mobile device can display the application selection screen. The application selection screen can display a list of user interface elements. The list of user interface elements corresponds to one or more applications. The mobile device can detect a second contact on the touch-sensitive screen. The second contact can correspond to a user interface element corresponding to one of the listed applications. In response to detecting the second contact corresponding to the user interface element corresponding to one of the listed applications, the mobile device can (a) cease to display the application selection screen, and (b) add an application launch icon corresponding to the user interface element corresponding to one of the listed applications to the control interface.

According to one implementation, there may be a limit to the quantity of application icons that can be added to control center interface 802. In such an implementation, if the addition of a new application icon causes that limit to be reached, then add icon 804 ceases to be displayed in control center interface 802, and does not reappear unless and until one or more application icons are deleted or otherwise removed form control center interface 802. A technique for removing an application from control center interface 802 is described further below.

According to another implementation, there may be a large quantity of separate virtual pages or rows into which newly added application icons can be expanded. In such an implementation, when the current virtual page or row is filled, a new virtual page or row can be created for control center interface 802, and add icon 804 can be moved to the leftmost position in that new virtual page or row.

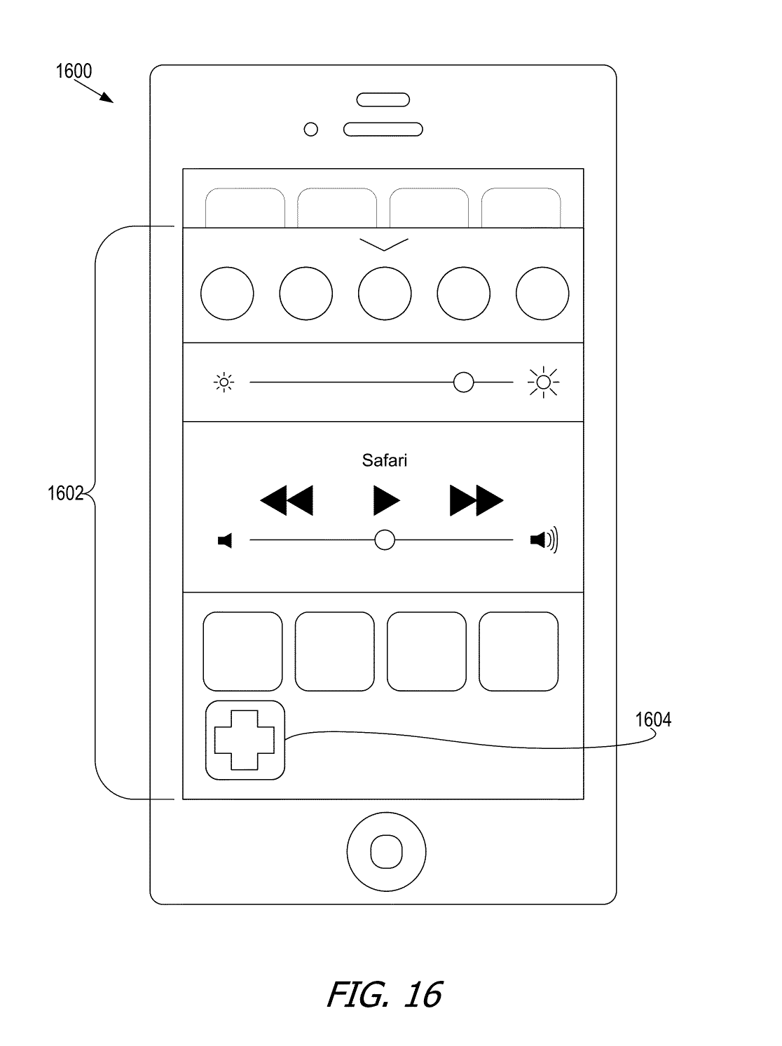

FIG. 16 is a diagram that illustrates an example 1600 of a control center interface 1602 that includes a control that can be operated to add a new application to multiple rows of application icons in control center interface 1602, according to an embodiment of the invention. In this implementation, two rows of application icons are displayed concurrently in control center interface 1602. As in FIG. 8, an add icon 1604 is also shown in the bottom row. In such an embodiment, the add icon can begin within the top row of application icons. The mobile device can move the add icon to the bottom row in response to determining that the top row has been filled.

Removing an Application Icon from the Control Center Interface

According to one technique, the mobile device can be placed into a special reconfiguration mode in which the movement and removal of application icons can be performed. U.S. Patent Application Publication No. 2011/0252370 (U.S. patent application Ser. No. 12/888,389) is incorporated by reference herein. U.S. Pat. No. 8,291,344 is also incorporated by reference herein. U.S. Patent Application Publication No. 2011/0252380 (U.S. patent application Ser. No. 12/888,382) is also incorporated by reference herein. U.S. Patent Application Publication No. 2011/0252376 (U.S. patent application Ser. No. 12/888,386) is also incorporated by reference herein. U.S. Patent Application Publication No. 2011/0252369 (U.S. patent application Ser. No. 12/888,381) is also incorporated by reference herein. U.S. Patent Application Publication No. 2011/0252357 (U.S. patent application Ser. No. 12/888,384) is also incorporated by reference herein. Each of the foregoing publications further discusses examples of a reconfiguration mode.

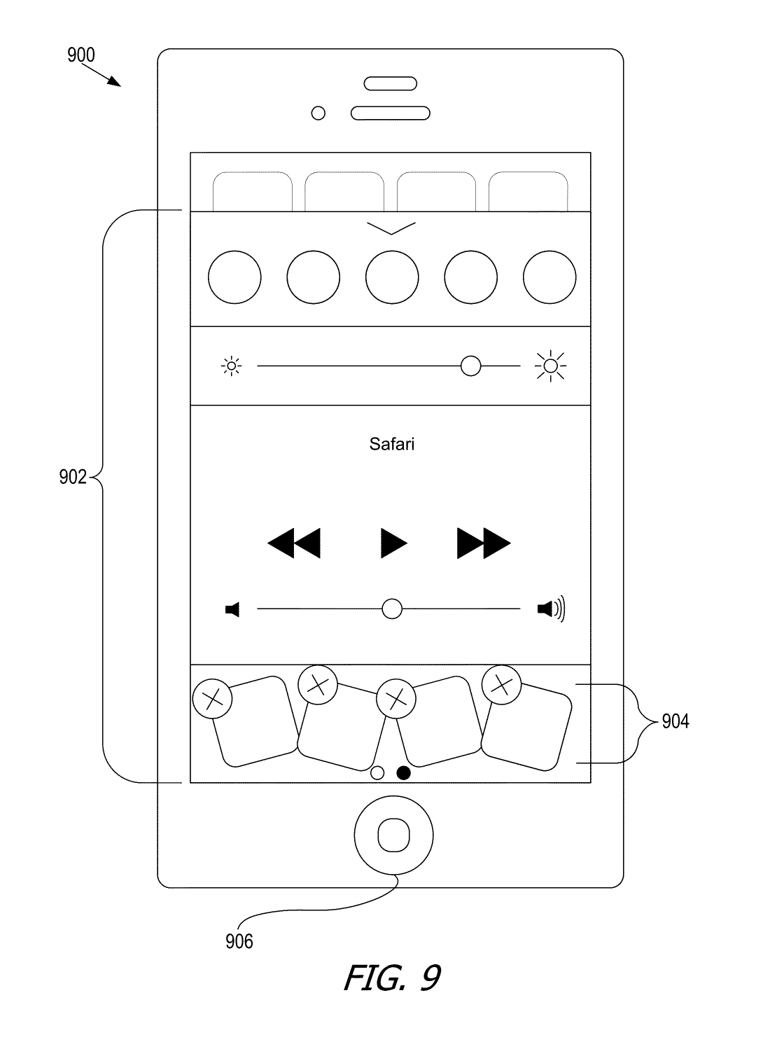

FIG. 9 is a diagram that illustrates an example 900 of a control center interface 902 that has entered a mode in which application icons are selectable for removal from control center interface 902, according to an embodiment of the invention. In an embodiment, the mobile device can enter this reconfiguration mode in response to detecting continuous user contact at the location of one of application icons 904 for at least a specified threshold amount of time. Upon entering this reconfiguration mode, the mobile device can add a deletion indicator (appearing as a circle including an X) to the upper left corner of each of application icons 904. Additionally, upon entering this reconfiguration mode, the application icons can be visually distinguished. For example, the mobile device can animate each of application icons 904, causing them to jiggle slightly left, right, up, and down, and to rotate slightly clockwise and counter-clockwise in alternation.

While in the reconfiguration mode, the mobile device can detect a user tapping gesture relative to a particular one of application icons 904. In response, the mobile device can ask the user whether he actually intends for the selected application icon to be removed from control center interface 902. If the mobile device receives an affirmative verification to this inquiry, the mobile device can remove the selection application icon from control center interface 902, potentially causing other application icons to shift positions to occupy its former space, and potentially causing an add icon (discussed above in connection with FIGS. 6 and 8) to reappear. In an embodiment, removal of the selected application icon from control center interface 902 does not also cause the corresponding application to be removed from the memory of the mobile device, or from other segments of the user interface in which that application might also exist.

According to an implementation, the mobile device can remain in the reconfiguration mode discussed above until some specified event occurs. For example, the mobile device can remain in the reconfiguration mode until it detects that a home button 906 has been depressed. Thereafter, the mobile device can exit the reconfiguration mode and can cease animating application icons 904 in the manner described above. Thus, in one embodiment, while displaying a control interface, the mobile device can detect continuous user contact relative to a location of an application launch icon for at least a specified amount of time. In response to detecting the continuous user contact, the mobile device can do the following. The mobile device can place itself into a reconfiguration mode. The mobile device can also visually distinguish the one or more displayed application launch icons. Additionally, while the mobile device is in the reconfiguration mode, the mobile device can detect a separate user contact relative to the location of the application launch icon. In response to detecting the separate user contact while the mobile device is in the reconfiguration mode, the mobile device can remove the application launch icon from the control interface while maintaining the application launch icon on the mobile device within a graphical interface that is separate from the control interface. Furthermore, the mobile device can remove the application launch icon from the control interface while maintaining, in its memory, the application that the application launch icon launches. Thus, that application still can be launched.

Dragging an Application Icon into the Control Center Interface

In one embodiment, the mobile device provides functionality that enables a user to drag an application icon from the springboard or dock into the control center interface. In various alternative embodiments, this dragging can either move the application icon from its former location to the control center interface, or can create an additional copy of the application icon in the control center interface, maintaining the original in place.

The mobile application can enter the reconfiguration mode described above in response to detecting continuous contact relative to an application icon in the springboard or dock. While in the reconfiguration mode, the mobile device can detect a dragging gesture relative to a particular application icon. The mobile device can move the particular application icon along point of user contact with the touch-sensitive display. When the particular application icon has reached the vicinity of the bottom of the screen, the mobile device can reveal the control center interface (as might be typical when user contact is made with that vicinity of the user interface in other modes).

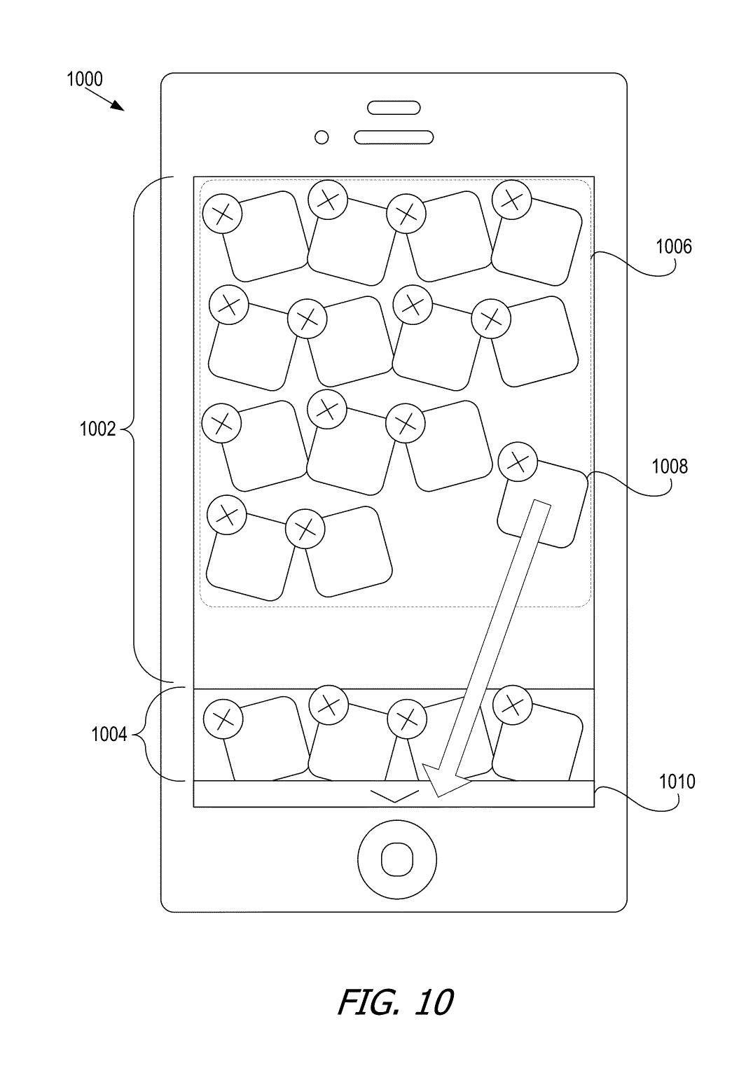

In terms of a layered presentation, the mobile device can raise the control center display over the springboard and behind the application icon that is being dragged. The mobile device can detect the release and cessation of the dragging gesture while the control center display is being displayed. In response, the mobile device can add the released application icon to the control center interface, potentially into a row of application icons that are already present within the control center interface. An example of this addition-by-dragging process is discussed below in connection with the FIGS. 10-12.

FIG. 10 is a diagram that illustrates an example 1000 of a springboard 1002 in which an reconfiguration mode has been entered, according to an embodiment of the invention. As is discussed above, continuous user contact with the touch-sensitive display for at least a specified amount of time can cause the mobile device to enter the reconfiguration mode. In an embodiment, the typical application removal functionality is also effective while the mobile device is in the reconfiguration mode.

As shown in FIG. 10, application icons 1006 in springboard 1002 and dock 1004 have been animated. A user has selected a particular application icon 1008 and is dragging application icon 1008 downward toward the bottom of the display. When application icon 1008 reaches the vicinity of the bottom of the display, the mobile device can begin to raise control center interface 1010 from the bottom of the display, overlaying springboard 1002.

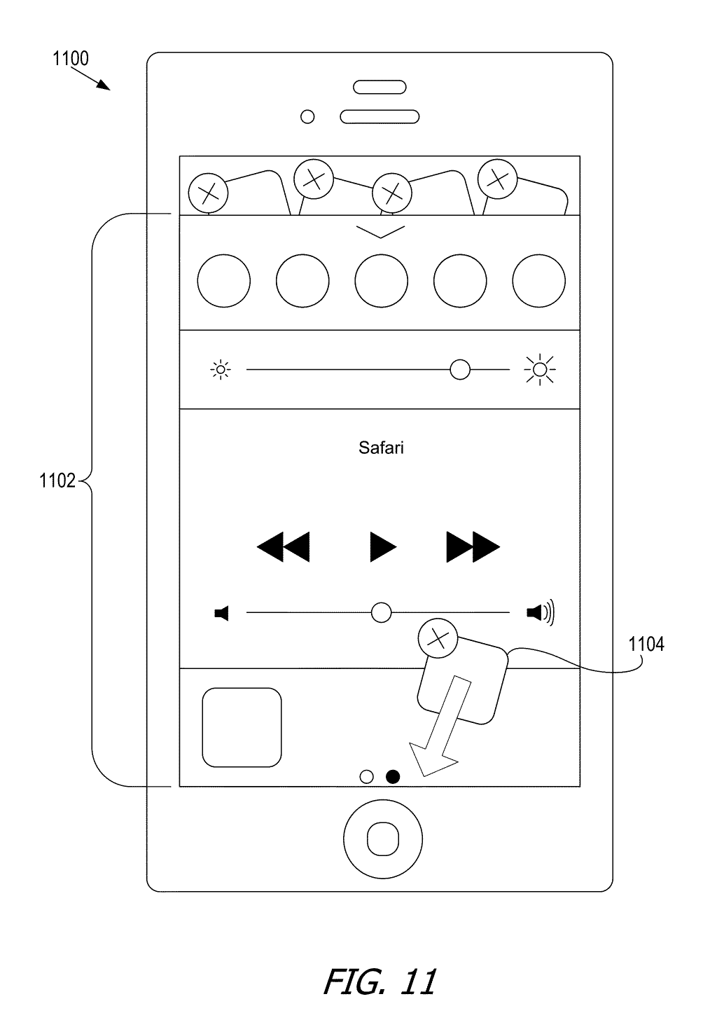

FIG. 11 is a diagram that illustrates an example 1100 of a control center interface 1102 that has been raised over a springboard while an application icon is being dragged into control center interface 1102, according to an embodiment of the invention. As shown in FIG. 11, the mobile device remains in the reconfiguration mode, which is apparent from the jiggling of the application icons still visible in the fraction of the springboard that has not been obscured by the raising of control center interface 1102. The mobile device is moving application icon 1106 (analogous to application icon 1008 of FIG. 10) along the path of the dragging gesture that the mobile device detects.

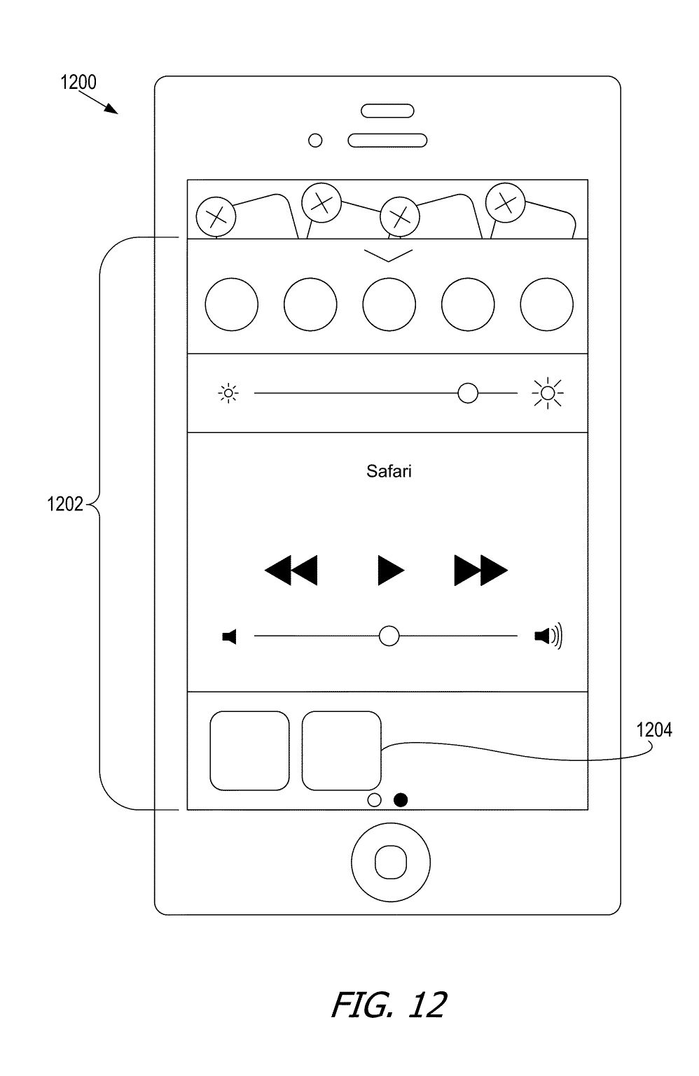

FIG. 12 is a diagram that illustrates an example 1200 of a control center interface 1202 into which an application icon has been dragged from a springboard, according to an embodiment of the invention. Upon detecting the cessation of user contact with the touch-sensitive display, and the consequent termination of the dragging gesture, the mobile device can determine that a released application icon 1204 (analogous to application icon 1106 of FIG. 11) is in the vicinity of the application icon area at the bottom of control center interface 1202. Responsively, the mobile device can cease the animation of application icon 1204 and can align application icon 1204 within the application icon area, next to other application icons that might already exist in that area. The release of application icon 1204 into this area effectively causes the mobile device to add application icon 1204 to control center interface 1202.

In one implementation, the dragging of application icon 1204 from the springboard into control center interface 1202 is handled in a manner similar to that in which a mobile device handles the dragging of an application icon from the springboard into a folder or group that is present within the springboard.

### Selective Concealment of the Add Icon Until Reconfiguration Mode is Entered

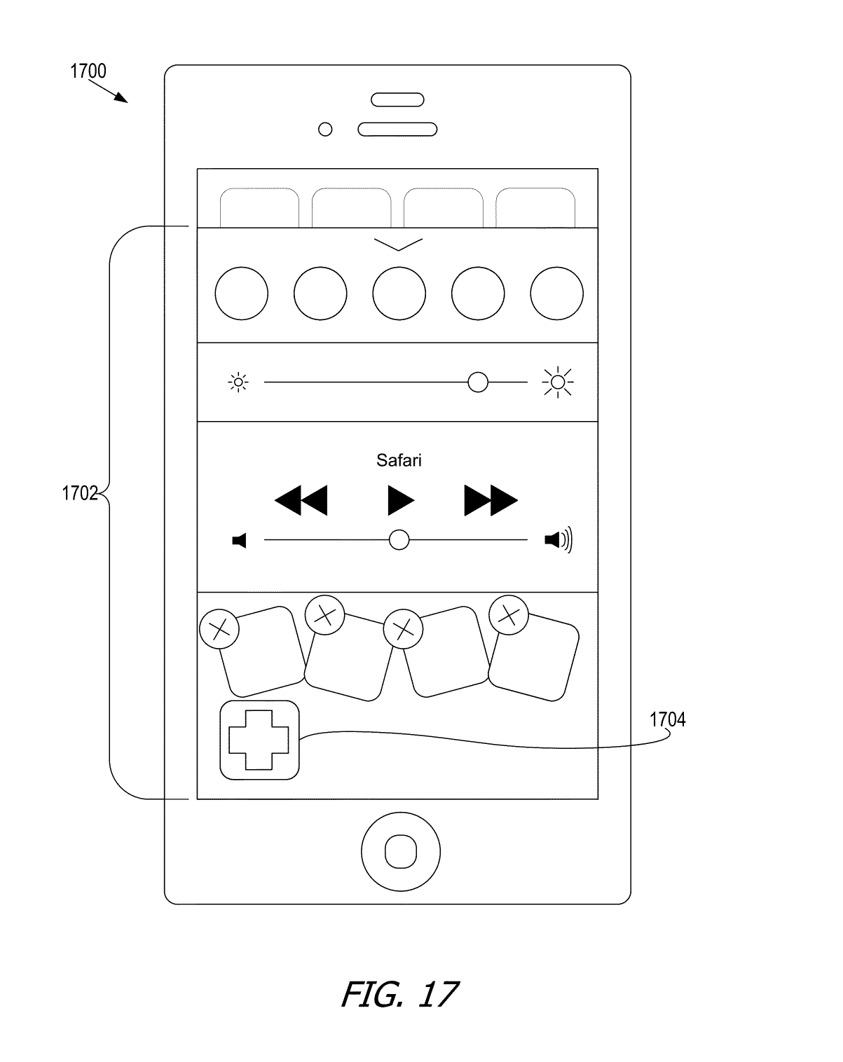

FIG. 17 is a diagram that illustrates an example 1700 of a control center interface 1702 that includes an application-adding control that appears in response to the mobile device being placed in an reconfiguration mode, according to an embodiment of the invention. In the example of FIG. 17, an add icon 1704 may be concealed until the mobile device is placed in the reconfiguration mode. In response to the mobile device being placed in the reconfiguration mode, the mobile device can animate the application icons, shift the row of application icons upward if the row is full, and then present add icon 1704 in the new row created by the upward shift. Add icon 1704 then can be used to add a new application icon to control center interface 1702 in a manner similar to that discussed above in connection with FIGS. 6-8.

Adding an Application Icon into the Control Center Interface Through a Settings Menu

A mobile device can have a settings dialogue or menu that can include different settings interfaces for various different applications that are stored on the mobile device. Each settings interface can include controls through which a user can set values of parameters that pertain to the corresponding application. One such settings interface can pertain to the control center discussed above. In an embodiment, the control center settings interface, accessed from the mobile device's general settings dialogue or menu, provides functionality whereby an application icon can be added to the control center interface.

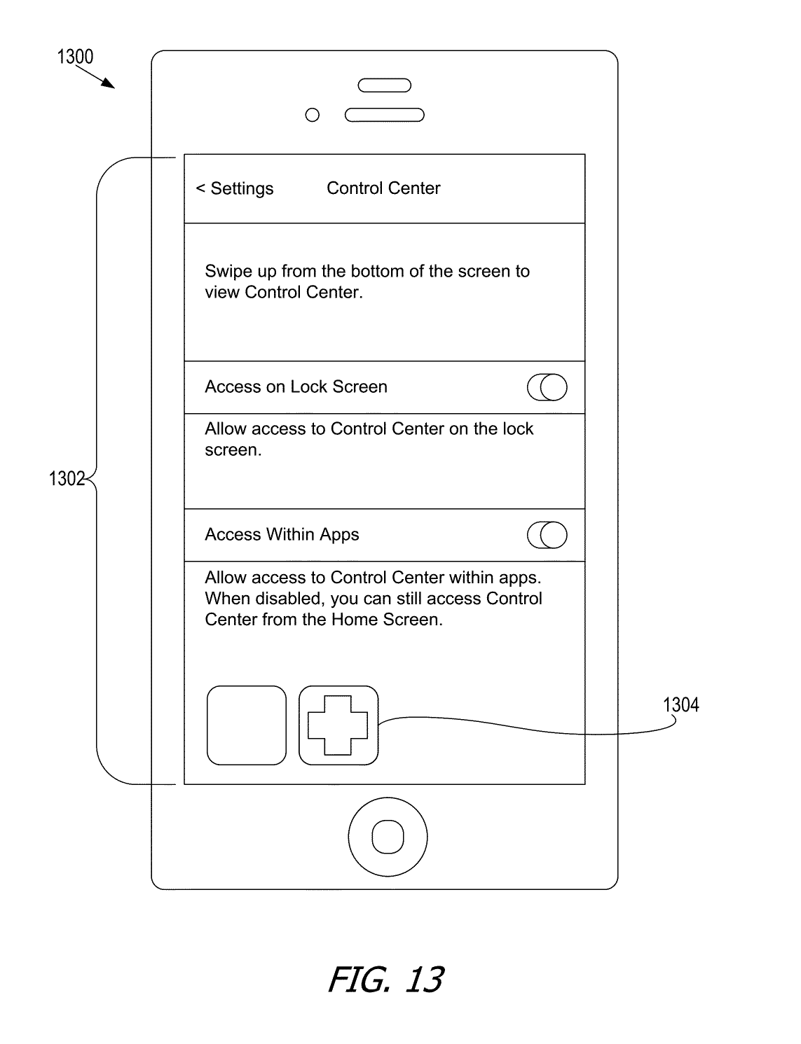

FIG. 13 is a diagram that illustrates an example 1300 of a control center settings interface 1302 that shows application icons that are already contained in the control center and an add icon that can be used to add new application icons to the control center, according to an embodiment of the invention. Control center settings interface 1302 includes an add icon 1304 that functions similarly to add icon 604 of FIG. 6.

The mobile device can detect a user tapping gesture relative to add icon 1304 within control center settings interface 1302. In response to detecting such a gesture, the mobile device can display a list of applications similar to that shown by way of example in FIG. 7. The mobile device can detect a user's selection of an application from the list. The mobile device can then responsively add, to the set of other application icons shown in control center settings interface 1302, an application icon corresponding to the selected application. The addition also has the effect of adding the selected application icon to the control center interface.

### Modifying Default Settings for Application Icons in the Control Center

In one embodiment, through the control center settings interface, the mobile device can provide a mechanism through which a user can select custom default settings or functionality for various applications that can have corresponding application icons in the control center interface. For example, using this mechanism, a user can instruct the mobile device that a particular function, from a set of functions provided by a particular application, is to be invoked whenever that particular application's icon is activated (e.g., tapped) within the control center interface.

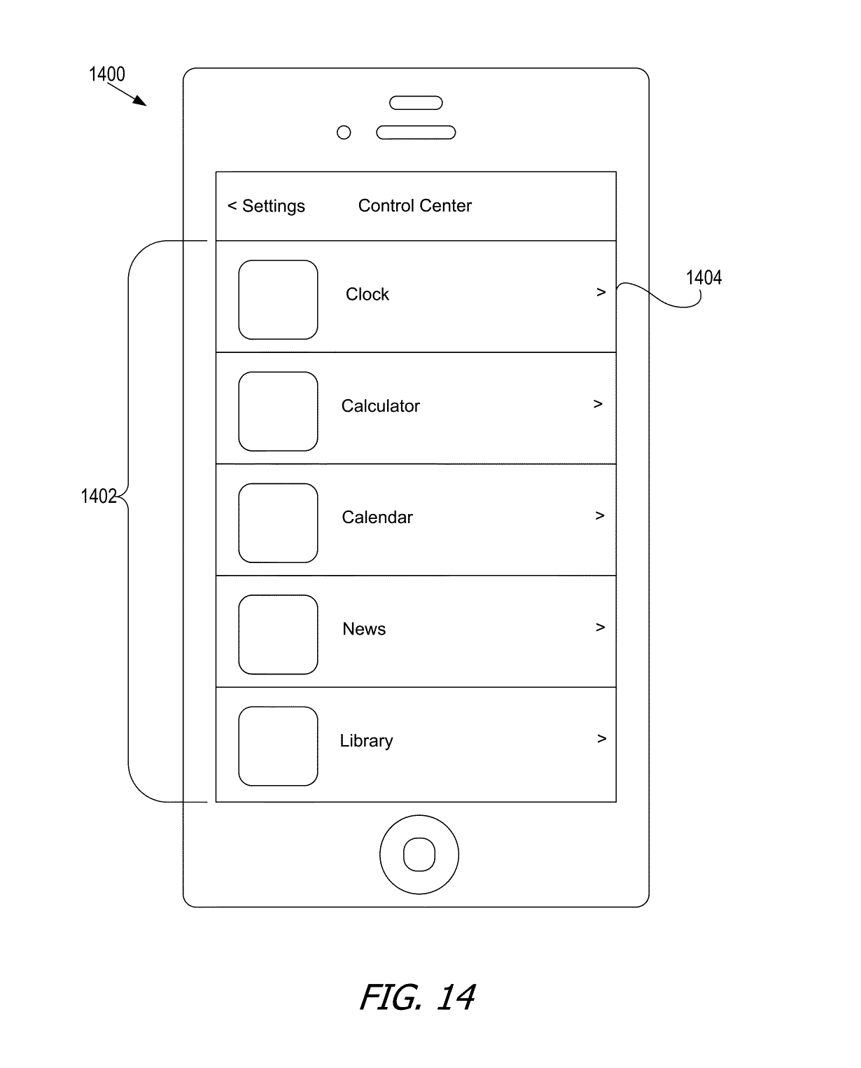

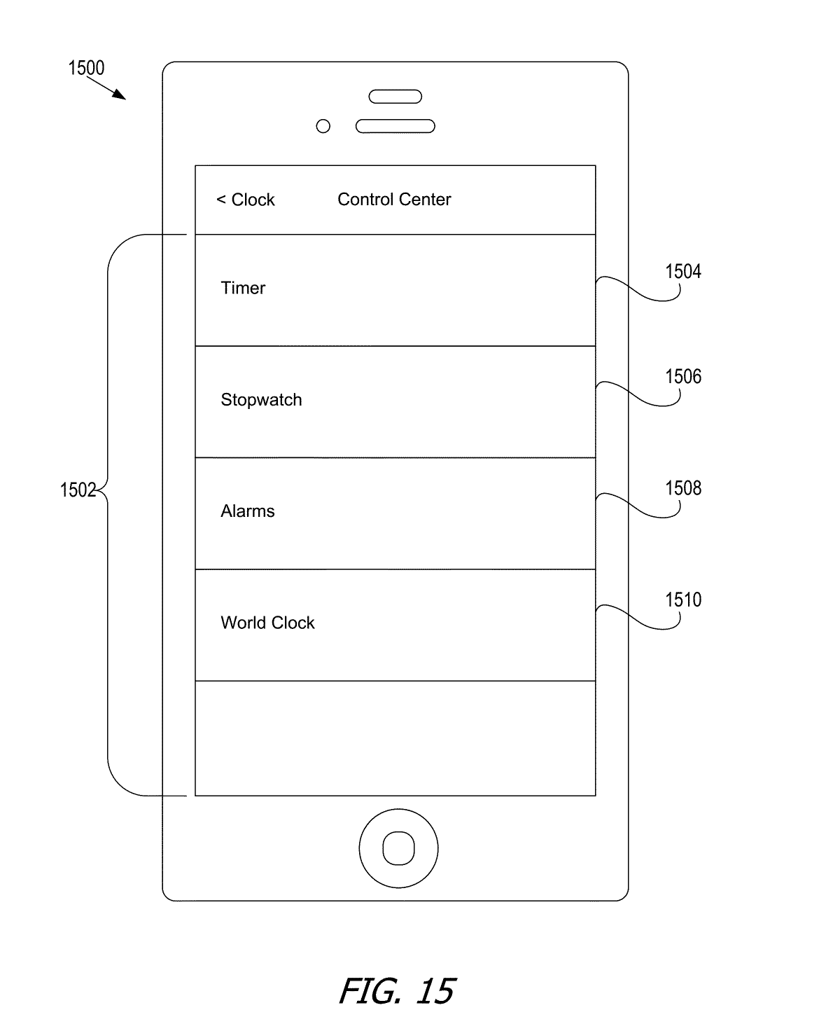

FIG. 14 is a diagram that illustrates an example 1400 of a control center settings interface 1402 that shows multiple applications for which default functionality can be specified, according to an embodiment of the invention. Control center settings interface 1402 includes an application list 1404 of at least some of the applications that are stored on the mobile device. In the example shown, application list 1404 includes, among other applications, a clock application 1406. In response to detecting user selection of clock application 1406 from application list 1404, the mobile device can present a set of default functions that are specific to the selected application—in this example, clock application 1406. An example interface including such a set of default functions in discussed in connection with FIG. 15 below.

FIG. 15 is a diagram that illustrates an example 1500 of a control center settings interface 1502 that includes a list of default functions that can be invoked upon application launch of a previously selected application, according to an embodiment of the invention. The list shown in FIG. 15 is specific to clock application 1406 of FIG. 14. The list of default functions includes a timer 1504, a stopwatch 1506, alarms 1508, and a world clock 1510. The mobile device can detect a user's selection of any of these default functions from interface 1502.

In response to detecting a user's selection of a particular default function from default functions 1504-1510, the mobile device can store a configuration for the previously selected application (in this example, clock application 1406). The configuration specifies the functionality that the mobile device is to invoke automatically whenever the application is launched via its application icon from the control center interface, such as is shown in FIG. 4, for example. Thus, if the mobile device detects that stopwatch 1506 has been selected from interface 1502, then mobile device will store a configuration that specifies that stopwatch functionality is to be invoked automatically whenever the application icon for clock application 1406 is activated from the control center interface.

After an application-specific configuration has been generated in the manner described above, the mobile device can detect the user's tapping of a particular application from the control center interface. In response, the mobile device can consult the stored configuration for the particular application. The mobile device can automatically invoke the selected default functionality of that particular application as specified in the stored configuration.

Making the Control Center Interface Transparent while a Slider Control is being Operated

In one embodiment, the activation of a slider control within the control center interface causes the mobile device to “fade out,” or gradually make at least partially transparent, all of the visual aspects of the control center interface except for the slider control that is currently being operated. This fading of the control center interface can change the normally opaque background of the control center interface to be partially or fully transparent, so that the content that the control center interface overlays becomes partially or fully visible during the user's operation of the slider control. Revealing the content that otherwise would be hidden beneath the control center interface layer causes the effect of the movement of the slider control's thumb, and the corresponding modification of the associated parameter's value, to become apparent relative to that content while the thumb is being moved.

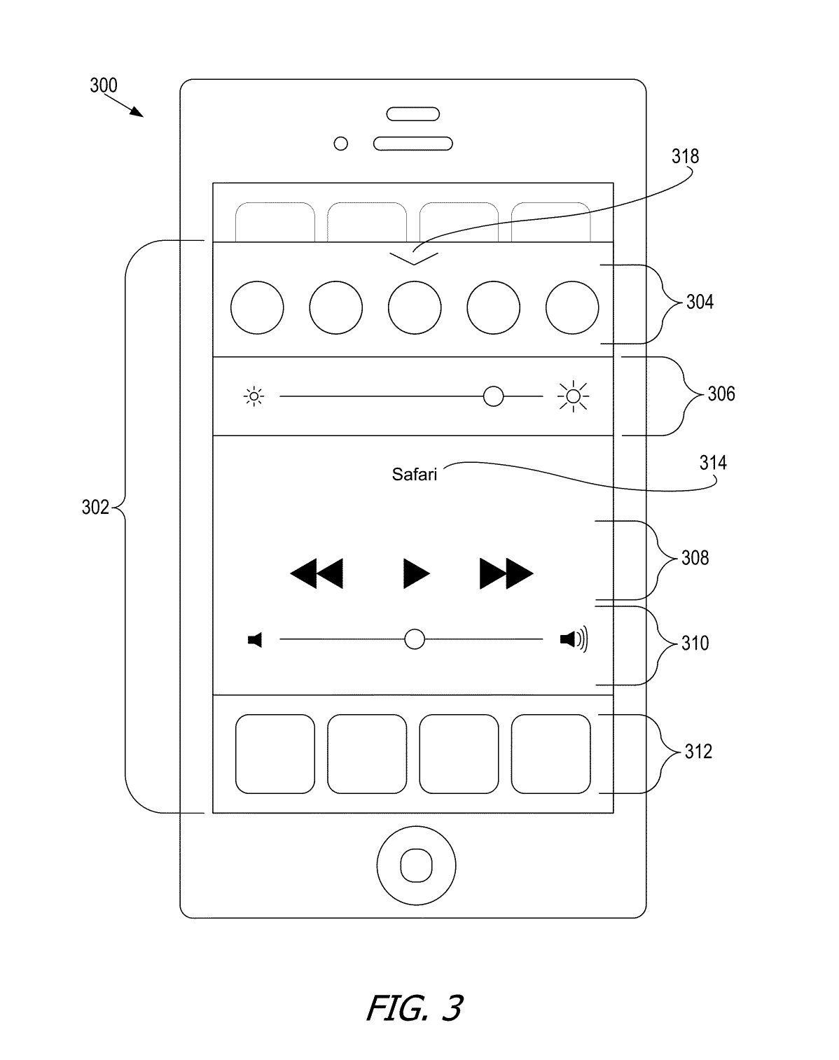

Prior to the user's operation of a slider control, the control center interface can appear in an opaque manner similar to that shown in FIG. 3, for example. However, as soon as the mobile device detects that one of the slider controls—such as slider controls 306 and 310 of FIG. 3—is being operated, the mobile device can begin to fade out, either gradually or instantly, all of the visual components of the control center interface except for the slider control that is currently being operated. In the example below, the operation of brightness slider control 306 will be considered.

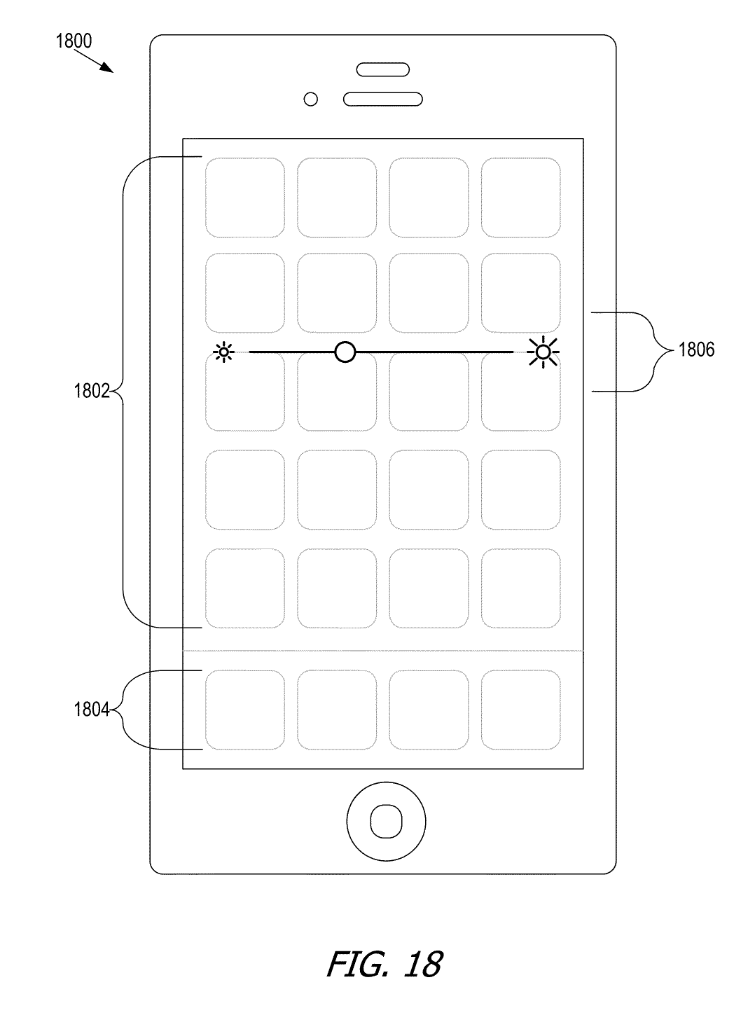

FIG. 18 is a diagram that illustrates an example 1800 of a control center interface 1802 that has been made transparent except for a slider control that is currently being operated, according to an embodiment of the invention. All of the other visual components and controls of the control center interface that were present in FIG. 3 have vanished. Only brightness slider control 1806 remains displayed from among those controls. The new transparency of control center interface 1802 has caused the content previously concealed behind that interface to become visible.

In the example shown in FIG. 18, the newly revealed content includes the application icons within springboard 1802 and dock 1804. However, inasmuch as control center interface 1802 can be raised from any of the mobile device's states, the revealed background content could be visual content that is presented by some application that executed on the device. Such background content could include, for example, a still photographic image or a motion video.

As the mobile device detects that the thumb of brightness slider control 1806 is being moved, the mobile device can accordingly modify the value of a brightness parameter that is applicable to all content that the mobile device currently displays or may display in the future. Thus, as the thumb is moved left and right, the effect of the change in the brightness setting relative to the content within springboard 1802 and deck 1804 may be apparent; the application icons contained therein may grow darker and brighter as the thumb is moved.

According to an implementation, the mobile device also can detect that user contact with brightness control slider 1806 has been released. In response, the mobile device can maintain the last brightness setting relative to the background content, and can restore control center interface 1802 to full opacity. The mobile device can make the other components and controls of control center interface 1802 reappear. The content of springboard 1802 and deck 1804 may be obscured to the same extent that they were prior to the commencement of the user's operation of brightness slider control 1806.

### Showing the Effects of the Operation of a Slider Control on Background Content During Operation

In an alternative embodiment, in response to detecting the commencement of the operation of a slider control in the control center interface, the mobile device does not make any aspects of the control center interface transparent. However, even in such an alternative embodiment, the effect of the operation of the slider control upon the background content can be made apparent to the user during the control's operation, in real time. This is possible because, in one implementation, the control center interface does not fully obstruct the background content when it partially overlays that background content. As shown in FIG. 3 and other figures, even while the control center interface is being presented, some of the background content may be visible at a top of the screen that the control center interface does not occupy.

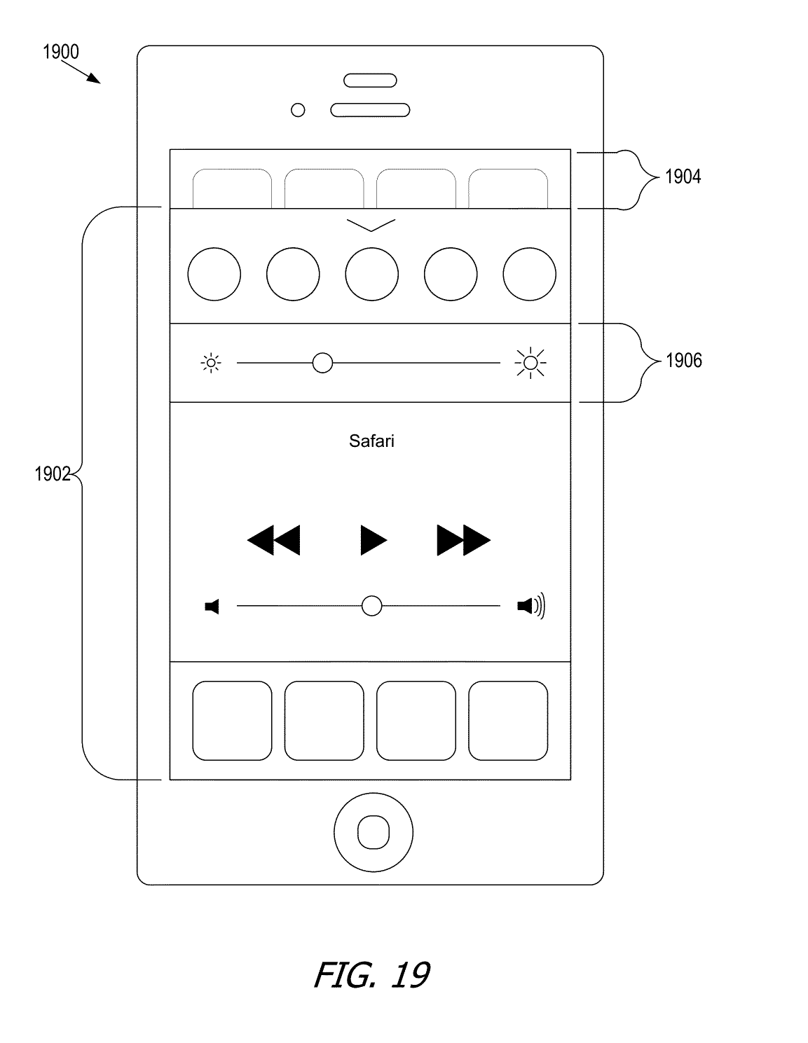

FIG. 19 is a diagram that illustrates an example 1900 of a control center interface 1902 including a slider control which, when activated, causes effects of the change in value of a parameter associated with that slider control to become apparent relative to background content visible in a portion of the display that control center interface 1902 does not occupy, according to an embodiment of the invention. While the thumb of slider control 1906 is being moved left and right, the mobile device modifies the value of a brightness parameter accordingly. While the value of the brightness parameter changes in this manner, the mobile device continuously updates the display of the visible portion 1904 of the background content to reflect the effect of the changed value upon that background content. Thus, while the thumb is being moved, the brightness of visible portion 1904 can be increased or decreased in real time.

In one embodiment, the refreshing of visible portion 1904 is not also carried over to control center interface 1902 itself while slider control 1906 is being operated. In such an embodiment, operation of slider control 1906 affects the presentation (e.g., brightness) of visible portion 1904, but the presentation (e.g., brightness) of control center interface 1902 remains constant. In one alternative embodiment, the user's release of the thumb of slider control 1906 causes the effect of the associated parameter's change to be applied to the aspects of control center interface 1902 as well. It should be appreciated that brightness is but one example of many different parameters having a value that a slider control could modify. Alternative embodiments of the invention are similarly applicable to other parameters such as, for example, contrast, sharpness, hue, etc.

### Separating Regions of the Control Center Through Differing Membrane Transparencies

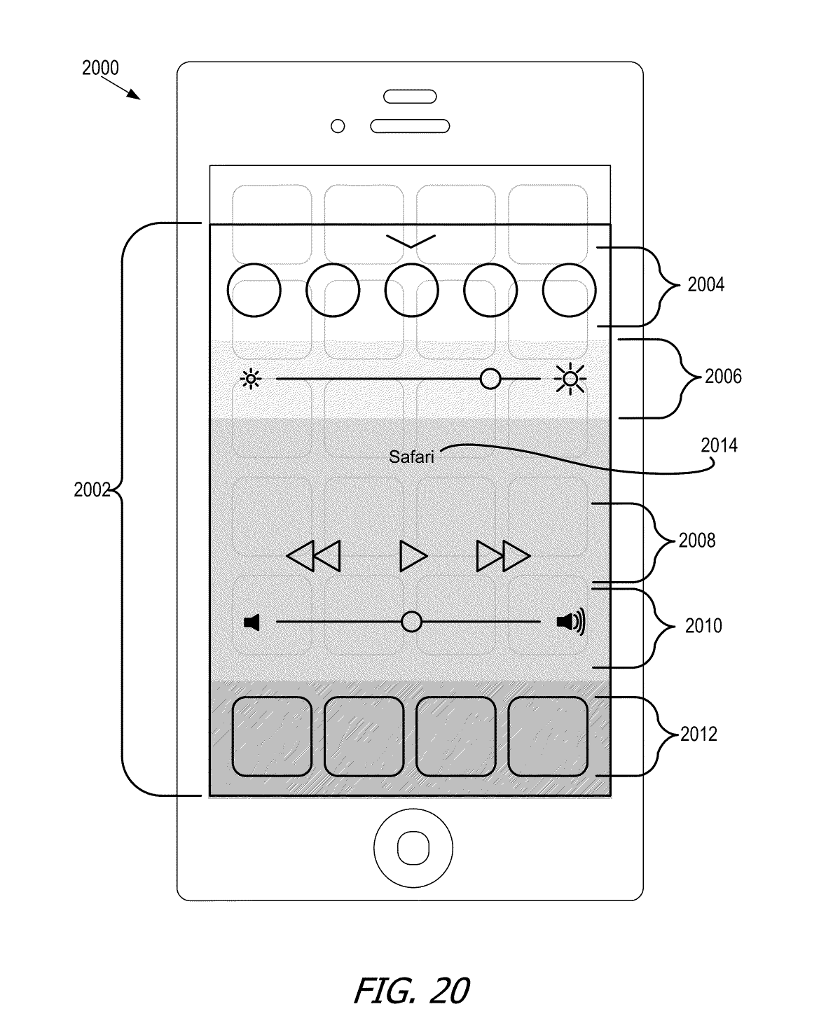

FIG. 20 is a diagram that illustrates an example 2000 of a control center interface 2002 in which different regions or sections of the control center are distinguished from each other via differing transparencies of membranes on which those regions or sections are composed. The background content over which control center interface 2002 is laid can be visible through the membranes to various extents, depending on the degrees of transparency of those membranes.

Thus, for example, the transparency of a section in which controls 2004 are contained might be 80% transparent. The transparency of a section in which controls 2006, 2014, 2008, and 2010 are contained might be 60% transparent. The transparency of a section in which application icons 2012 are contained might be only 40% transparent. As with some embodiments discussed above, the effects of the changes of parameter values associated with the controls upon the background content may be apparent in real-time due to the varying degrees of transparency.

### Hardware Overview

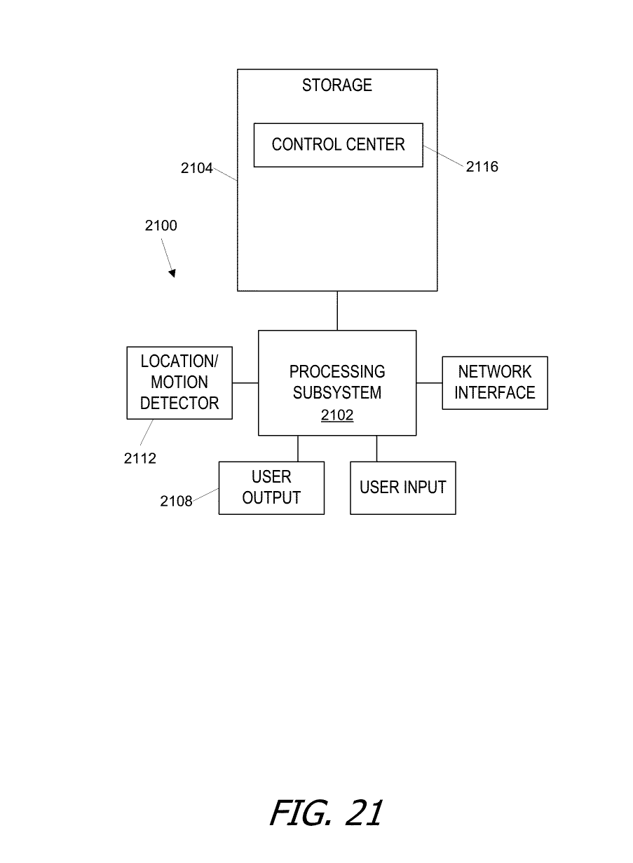

FIG. 21 is a simplified block diagram of an implementation of a device 2100 according to an embodiment of the present invention. Device 2100 can be a mobile device, a handheld device, a notebook computer, a desktop computer, or any suitable electronic device with a screen for displaying images. Device 2100 includes a processing subsystem 2102, a storage subsystem 2104, a user input device 2106, a user output device 2108, a network interface 2110, and a location/motion detector 2112.

Processing subsystem 2102, which can be implemented as one or more integrated circuits (e.g., e.g., one or more single-core or multi-core microprocessors or microcontrollers), can control the operation of device 2100. In various embodiments, processing subsystem 2102 can execute a variety of programs in response to program code and can maintain multiple concurrently executing programs or processes. At any given time, some or all of the program code to be executed can be resident in processing subsystem 2102 and/or in storage subsystem 2104.

Through suitable programming, processing subsystem 2102 can provide various functionality for device 2100. For example, processing subsystem 2102 can execute a control center application program (or “app”) 2116. Control center app 2116 can present user interface controls for varying the values of parameters of different applications that are also stored in storage subsystem 2104. Control center app 2116 can perform various embodiments described herein.

Storage subsystem 2104 can be implemented, e.g., using disk, flash memory, or any other storage media in any combination, and can include volatile and/or non-volatile storage as desired. In some embodiments, storage subsystem 2104 can store one or more application programs to be executed by processing subsystem 2102 (e.g., control center app 2116). In some embodiments, storage subsystem 2104 can store other data (e.g., used by and/or defined by control center app 2116). Programs and/or data can be stored in non-volatile storage and copied in whole or in part to volatile working memory during program execution.

A user interface can be provided by one or more user input devices 2106 and one or more user output devices 2108. User input devices 2106 can include a touch pad, touch screen, scroll wheel, click wheel, dial, button, switch, keypad, microphone, or the like. User output devices 2108 can include a video screen, indicator lights, speakers, headphone jacks, or the like, together with supporting electronics (e.g., digital-to-analog or analog-to-digital converters, signal processors, or the like). A customer can operate input devices 2106 to invoke the functionality of device 2100 and can view and/or hear output from device 2100 via output devices 2108.

Network interface 2110 can provide voice and/or data communication capability for device 2100. For example, network interface 2110 can provide device 2100 with the capability of communicating with an external server. In some embodiments network interface 2110 can include radio frequency (RF) transceiver components for accessing wireless voice and/or data networks (e.g., using cellular telephone technology, advanced data network technology such as 21 G, 4 G or EDGE, WiFi (IEEE 2102.11 family standards, or other mobile communication technologies, or any combination thereof), and/or other components. In some embodiments network interface 2110 can provide wired network connectivity (e.g., Ethernet) in addition to or instead of a wireless interface. Network interface 2110 can be implemented using a combination of hardware (e.g., antennas, modulators/demodulators, encoders/decoders, and other analog and/or digital signal processing circuits) and software components.

Location/motion detector 2112 can detect a past, current or future location of device 2100 and/or a past, current or future motion of device 2100. For example, location/motion detector 2112 can detect a velocity or acceleration of mobile electronic device 2100. Location/motion detector 2112 can comprise a Global Positioning Satellite (GPS) receiver and/or an accelerometer. In some instances, processing subsystem 2102 determines a motion characteristic of device 2100 (e.g., velocity) based on data collected by location/motion detector 2112. For example, a velocity can be estimated by determining a distance between two detected locations and dividing the distance by a time difference between the detections.

It will be appreciated that device 2100 described herein is illustrative and that variations and modifications are possible. A device can be implemented as a mobile electronic device and can have other capabilities not specifically described herein (e.g., telephonic capabilities, power management, accessory connectivity, etc.). In a system with multiple devices 2100, different devices 2100 can have different sets of capabilities; the various devices 2100 can be but do not need to be similar or identical to each other.

Further, while device 2100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Additionally, while device 2100 is described as a singular entity, it is to be understood that it can include multiple coupled entities. For example, device 2100 can include a server, a set of coupled servers, a computer and/or a set of coupled computers.

Any of the computer systems mentioned herein may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components.

The subsystems can be interconnected via a system bus. Additional subsystems can be a printer, keyboard, fixed disk, monitor, which can be coupled to display adapter. Peripherals and input/output (I/O) devices, which couple to an I/O controller, can be connected to the computer system by any number of means known in the art, such as serial port. For example, serial port or external interface (e.g. Ethernet, Wi-Fi, etc.) can be used to connect computer system to a wide area network such as the Internet, a mouse input device, or a scanner. The interconnection via the system bus can allow the central processor to communicate with each subsystem and to control the execution of instructions from system memory or the fixed disk, as well as the exchange of information between subsystems. The system memory and/or the fixed disk may embody a computer readable medium. Any of the values mentioned herein can be output from one component to another component and can be output to the user.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method comprising:
displaying, on a touch-sensitive screen, a control interface that includes a plurality of user interface elements operable to modify settings of a plurality of applications accessible on the device, the user interface elements including an application addition element, that when activated, displays an application selection screen;
detecting a first contact on the touch-sensitive screen, the first contact corresponding to the application addition element;
in response to detecting the contact corresponding to the application addition element, displaying the application selection screen, the application selection screen displaying a list of user interface elements, the list of user interface elements corresponding to one or more applications;
detecting a second contact on the touch-sensitive screen, the second contact corresponding to a user interface element corresponding to one of the listed applications; and
in response to detecting the second contact corresponding to the user interface element corresponding to one of the listed applications:
ceasing to display the application selection screen, and
adding an application launch icon corresponding to the user interface element corresponding to one of the listed applications to the control interface.

2. The method of claim 1, further comprising:
displaying the application launch icon in a row of one or more application launch icons in the control interface.

3. The method of claim 2, further comprising
determining that a maximum number of application launch icons is presently displayed in the row of one or more application launch icons;
in response to the determining that a maximum number of application launch icons is presently displayed in the row of one or more application launch icons:
displaying, in the control interface, a new row concurrently with the row containing maximum number of application launch icons, and
adding the application launch icon to the new row.

4. The method of claim 2, further comprising:
determining that a maximum number of application launch icons is presently displayed in the row of one or more application launch icons; and
in response to the determining that a maximum number of application launch icons is presently displayed in the row of one or more application launch icons:
creating, in the control interface, a pagination indicator including a separate element for each page of a plurality of pages of the control interface, and
adding the application launch icon to a new row of application launch icons on a second page that is not displayed concurrently with a first page on which the maximum number of application launch icons was displayed;
wherein the first page and the second page are included within the plurality of pages.

5. The method of claim 1, wherein the plurality of user interface elements includes a set of toggles, one or more slider controls, and one or more application launch icons operable to launch one or more corresponding applications stored in a memory of the device.

6. The method of claim 1, further comprising:
while displaying the control interface, detecting a continuous contact on the touch-sensitive screen relative to a location of an application launch icon for at least a specified amount of time;
in response to detecting the continuous user contact:
placing the device into a reconfiguration mode, and
visually distinguishing the one or more displayed application launch icons;
while the device is in the reconfiguration mode, detecting a contact relative to the location of the application launch icon;
in response to detecting the contact while the device is in the reconfiguration mode, removing the application launch icon from the control interface.

7. The method of claim 6, wherein removal of the application launch icon from the control interface does not remove the application from the device.

8. The method of claim 1, further comprising:
displaying a list of default functions that the application launched by the application launch icon provides;
detecting a third user input on the touch-sensitive screen that selects a particular default function from the list of default functions;
storing a configuration that associates the application with the particular default function;
detecting a fourth input on the touch-sensitive screen, the fourth input corresponding to the application launch icon; and
in response to receiving the fourth input, launching the application and invoking the particular default function associated with the application in the configuration.

9. A method comprising:
displaying, on a touch-sensitive screen of a device, a control interface that includes a plurality of user interface elements operable to modify settings of a plurality of different applications accessible on the device;
detecting, on the touch-sensitive screen, first user input indicative of an intent to add an application launch icon to the control interface;
detecting, on the touch-sensitive screen, second user input that selects an application from the plurality of applications; and
adding, to the control interface, an application launch icon operable to cause the device to launch the application;
wherein the first user input involves a dragging gesture that moves the application launch icon corresponding to the application from a region external to the control interface toward a location that causes the control interface to become revealed after being obscured; and
wherein the second user input involves contact with the application launch icon at a commencement of the dragging gesture.

10. The method of claim 9, wherein the addition of the application launch icon to the control interface does not remove the application launch icon from a separate control interface of the device in which the application launch icon was contained prior to the addition.
